(19) United States
(12) Patent Application Publication
(10) Pub. No.: US 2008/0057895 A1
(43) Pub. Date: Mar. 6, 2008

(54) Hand-powered cell phone generator

(76) Inventor: Wen-Yeh Hsu, Cary, NC (US)

Correspondence Address: WEN-YEH HSU, 102 WHISPERWOOD DR, CARY, NC, 27511, US

(21) Appl. No.: 11/515,576

(22) Filed: Sep. 5, 2006

(51) Int. Cl. H04B 1/18

(52) U.S. Cl. 455/187.1

(57) ABSTRACT

A delicate device attaches to cell phones, which enables the user to charge up their cell phone by squeezing the handle of the generator. The mechanical force is transformed into useable direct current by a highly magnetic flywheel and a diode circuit.

### BACKGROUND AND BRIEF SUMMARY OF THE INVENTION

Cell phones are the most common used tool for communication in today's busy world. As technology advances cell phones increase their functions, they become more than just phone, which also decreases the battery life. As a result of multitasking functions, cell phone users are constantly looking for AC sources to charge their cell phones. This invention will solve the problem by an alternate charging process that does not require AC source.

### DETAILED DESCRIPTION OF THE INVENTION

The Hand-powered cell phone generator is a carefully designed slim box that compacts a mini hand-powered generator. Shown in FIG. 002 power is generated when the user squeeze the handle 006, the row of teeth 007 on the handle drive the main gear 024. Then the flywheel 035 activates the clutch arms 020 of the generator gear 019. The clutch arms 020 are placed in the hole 021 on the magnetic flywheel 022, which when rotates the silicon steel sensor 018 will cut the magnetic field. The generator sensor wires 017 transform the energy to AC voltage, and through circuit line 031 to diode bridge 032 that transform the AC voltage to DC voltage. Through the positive and negative lines 033 to DC output 034, where can be connected to charge cell phones.

This method of charging cell phones conserves energy and also solves the problem of looking for AC sources when cell phone users are on the go. Since there are countless models of cell phones in the market, the cell phone holder part can be picked out according to each consumer's need. The generator part will remain the same, and each cell phone holder will have a tongue-and-groove that enables the generator part to slide onto.

The Most important aspect of this invention is the mini generator that coverts energy when users squeeze the handle. With today's technology the generator can be designed to be slim and compact, as oppose to bulky and unattractive.

### BRIEF DESCRIPTION OF THE DRAWINGS

FIG. 001 Hand-powered cell phone generator

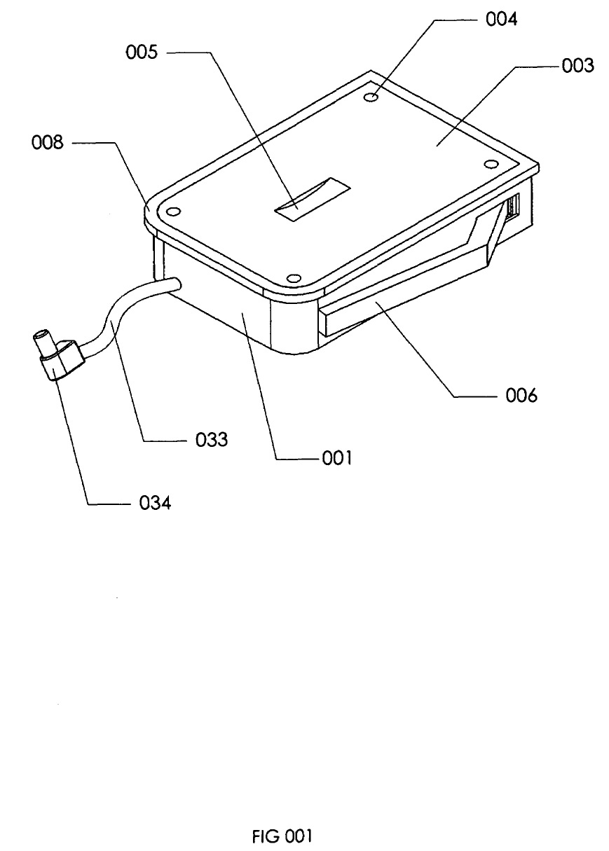

FIG. 002 Inner structure of the Hand-powered cell phone generator

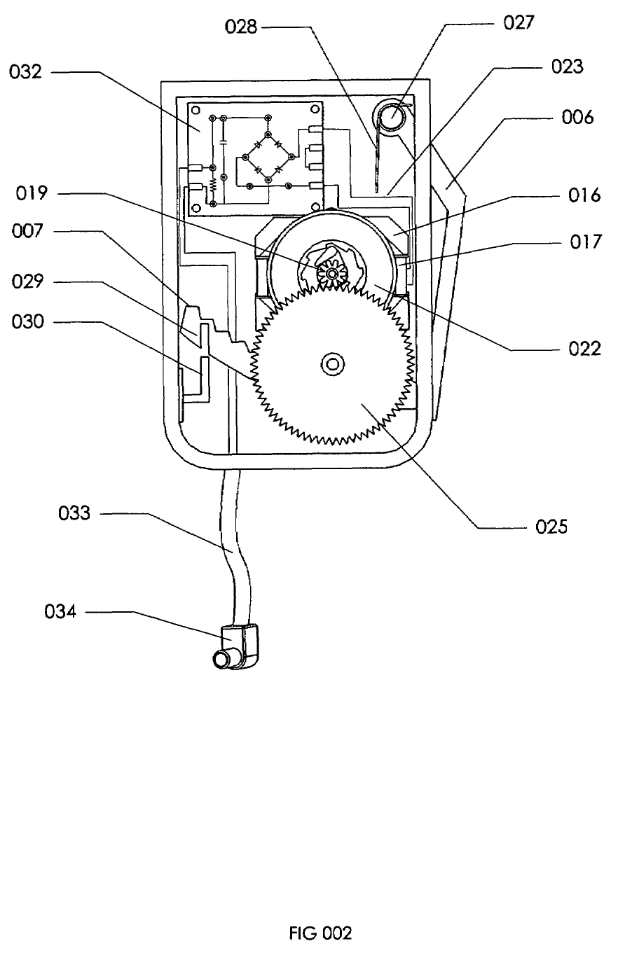

FIG. 003 The Hand-powered cell phone generator and cell phone holder

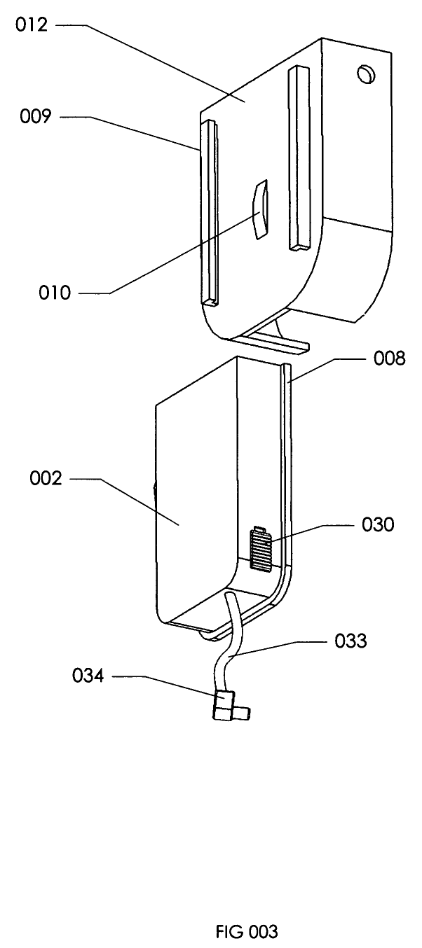

FIG. 004 Complete assembly of the Hand-powered cell phone generator

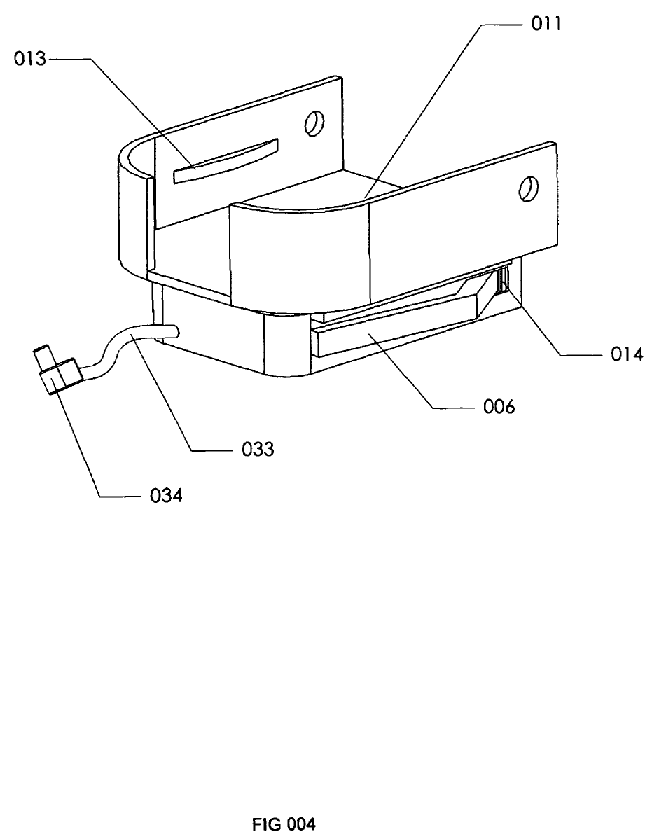

001 Generator box
002 Bottom of the generator box
003 Top/cover of the generator box
004 Screw
005 Slot for the generator
006 Generator handle
007 Teeth on the generator handle
008 Tongue to slide onto the cell phone holder
009 Groove on the cell phone holder
010 Tongue for the cell phone holder
011 Inner face of the cell phone holder
012 Outer face of the cell hone holder
013 Cell phone holder
014 Hole for the generator handle
015 Screw hole for the generator base
016 Generator base
017 Generator sensor wires
018 Silicon steel base
019 Generator activation driving gear
020 Generator activation gear
021 Slot for the clutch
022 Muilti-polar magnetic wheel
023 Generator AC output lines
024 Activation gear
025 Activation flywheel
026 Center shaft for the activation gear
027 Shaft for the handle
028 Spring
029 Closure clip slot
030 Closure clip
031 AC output
032 Diode bridge
033 DC output line
034 DC poutput plug

1. Generator that contains a highly magnetic flywheel that transform mechanical force into electricity, and with a diode circuit the electricity becomes direct current that can be used to charge up cell phones.
